(19) United States
(12) Patent Application Publication
(10) Pub. No.: US 2007/0260652 A1
(43) Pub. Date: Nov. 8, 2007

(54) Storage capacity query for UPnP AV media server CDS

(75) Inventors: Kari Kaarela, Oulu (FI); Kirmo Koistinen, Oulu (FI); Jukka Parkkinen, Oulu (FI); Timo Tervo, Oulu (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/429,730

(22) Filed: May 8, 2006

(51) Int. Cl. G06F 17/30

(52) U.S. Cl. 707/205

(57) ABSTRACT

A system and method for determining the remaining free storage capacity of a media database in a media server device (MSD), such as one used in a universal plug and play audio-visual (UPnP AV) architecture. The present invention allows a user of a MSD hosting a content directory service (CDS), prior to a large copy or move operation, to query the media database of the MSD as to the remaining free storage capacity. In one embodiment of the present invention, a query action is implemented in a control point (CP), allowing the CP to query the CDS, which in turn queries the MSD file system/operating system (OS) to determine the remaining free capacity storage of the media database. This capacity information is then sent back to the CP for presentation to a user of the MSD. In a second embodiment, the query is implemented as a dedicated AV MSD service. In a third embodiment, UPnP eventing and a new state variable capable of indicating the remaining free storage capacity is used.

### FIELD OF THE INVENTION

The present invention generally relates to current Universal Plug and Play (UPnP) audio visual (AV) media server specifications. In particular, the present invention relates to the implementation of a storage capacity query for querying the remaining storage capacity of a media server device that is hosting a content directory service.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

The Digital Living Network Alliance (DLNA) is an industry association that focuses on developing design guidelines to enable interoperability between various wired and wireless devices on a network(s). UPnP is one of the technical cornerstones of the DLNA. UPnP itself, is a set of computer network protocols promulgated by the UPnP Forum. UPnP technology defines an architecture for pervasive peer-to-peer network connectivity of intelligent appliances, wireless devices, and PCs of all form factors. It is designed to bring easy-to-use, flexible, standards-based connectivity to ad-hoc or unmanaged networks whether in the home, in a small business, public spaces, or attached to the Internet. UPnP technology further provides a distributed, open networking architecture that leverages TCP/IP and Web technologies to enable seamless proximity networking in addition to control and data transfer among networked devices.

The UPnP Device Architecture (UDA) is designed to support zero-configuration, “invisible” networking, and automatic discovery for a breadth of device categories from a wide range of vendors. Therefore, a UPnP device can dynamically join a network, obtain an IP address, convey its capabilities, and learn about the presence and capabilities of other devices on the network. To accomplish this, each UPnP device must have a Dynamic Host Configuration Protocol (DHCP) client and search for a DHCP server when the device first connects to the network. If no DHCP server is available, the device can assign itself an IP address. Once an IP address has been established, an exchange of discovery messages between the device and a control point occurs. The discovery messages utilizes a UPnP discovery protocol, which allows the device to advertise its services on the network, and a control point (CP) to seek those devices on the network that are of interest to the CP.

After the device has been discovered by a CP, the CP must retrieve a device description from a URL provided in the discovery message sent by the device. The device description can include anything from a list of embedded devices to services, as well as a list of commands or actions to which a certain service provided by the device responds to. Once the description is retrieved by the CP, the CP can send suitable control messages to interact with the service, to which the service responds by sending action-specific values that describe a run-time state of the service.

The next process in UPnP networking is event notification, or “eventing.” A UPnP description for a service includes a list of actions the service responds to and a list of variables that model the state of the service at run time. The service publishes updates when these variables change, and a CP may subscribe to receive this information. The service publishes updates by sending event messages that contain the names of one or more state variables and the current value of those variables.

The final step is presentation, which allows a user to control the device and/or view the status of the device. For example, if the device has a URL for presentation, the control point can retrieve a page from this URL, load the page into a Web browser, and present the page to the user.

UPnP defines device control protocols for a number of device categories on top of the UDA. These device control protocols define the services and their actions and state variables that the device in question offers for other peers in the UPnP network as described above. UPnP AV defines the device control protocol (DCP) for AV devices. Three components required by UPnP AV are a CP, a media server device (MSD), and a media renderer device (MRD).

Current UPnP AV media server specification define a versatile set of actions for searching, manipulating (e.g., create, delete and update) objects in the content directory service (CDS) portion of a MSD as well as importing and exporting content to/from the CDS. However, the media server specification does not include an action (or state variable) for querying the remaining storage capacity of the media server device hosting the CDS. Therefore, it is impossible for the CP to query the remaining free capacity prior to, e.g., starting a copy or move operation of a big chunk of data to the MSD. This may lead to an interruption in the copy operation due to insufficient storage capacity. This is frustrating from user's point of view, because such an operation should never be started if it is doomed to fail.

### SUMMARY OF THE INVENTION

The present invention comprises a system and method for determining the remaining free storage capacity of a media database in a MSD, such as one used in a UPnP AV architecture. In one embodiment of the present invention, a CP queries the CDS of an MSD as to the remaining free storage space on the media database contained within the MSD. The CDS can query the MSD file system/OS to determine this capacity information and forward the capacity information back to the CP. This is accomplished by simply adding a new query action to the MSD service description, and implementing the query action in the CDS operational software. In a second embodiment, the query is implemented as a dedicated AV MSD service. In a third embodiment, UPnP eventing and a new state variable capable of indicating the remaining free storage capacity is used.

The various embodiments of the present invention allow a user of an MSD, MRD, or UPnP network to determine whether or not any free remaining storage capacity is left on the MSD before or after, copying or moving AV content onto that MSD. This is also advantageous for a user when programming the recording of a live event or content, as live recordings can result in large-sized files. In either case, a query to determine the remaining free storage on the MSD makes it possible to predetermine whether the copy, move, or recording operation will succeed or fail. This minimizes the risk of wasted time in beginning a copy, move, or recording, only to have the action fail before completion. Furthermore, the implementations of the various embodiments of the present invention ensure backward compatibility with earlier AV MSDs because the query action is implemented as simply a new action option.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a perspective view of one embodiment of a media renderer device that can be used with the present invention;

FIG. 2 is a schematic representation of the electronic circuitry of the media renderer device of FIG. 1;

FIG. 3 is a representation of a UPnP AV architecture within which various embodiments of the present invention may be implemented;

FIG. 4 is a representation of a UPnP AV architecture including a Media Server Device template and Control Point Device template contemplated by various embodiments of the present invention; and

FIG. 5 is a flow chart showing the query procedure contemplated by various embodiments of the present invention.

### DETAILED DESCRIPTION OF THE PREFERRED EMBODIMENTS

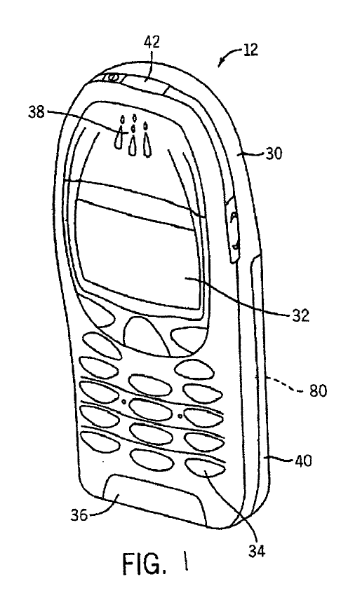

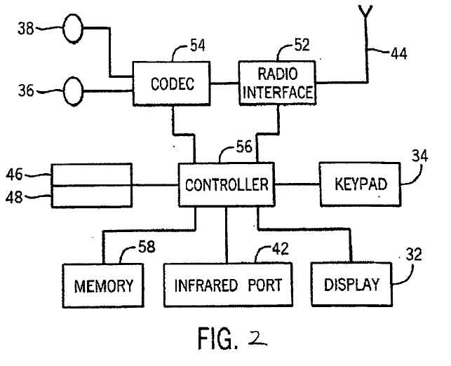

FIGS. 1 and 2 show one representative media renderer device 12 which may be used with various embodiments of the present invention. It should be understood, however, that the present invention is not intended to be limited to one particular type of electronic device. The media renderer device 12 of FIGS. 1 and 2 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones. Other possible types of media renderer devices include VCRs, DVD players, MP3 players, multimedia devices, set-top boxes, and the like.

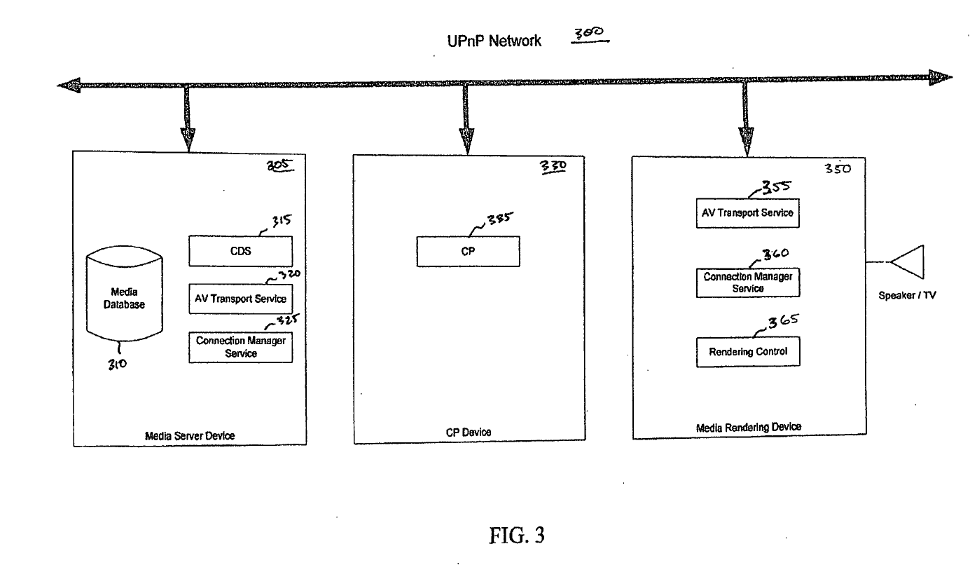

Referring to FIG. 3, a UPnP network 300 is shown having templates which represent a MSD 305, a CP device 330, and a MRD 350. The MSD 305 contains a media database 310 in which various types of media content can be stored and retrieved for presentation. In addition, the MSD 305 contains a CDS 315 which allows CPs to discover, if any, AV-type content that is available from the MSD 305. An AV transport service 320 is shown, which enables control over the transport of AV content to and from the MSD 305. A connection manager service 325 allows an actual instance of the AV transport service 320 to be established depending upon whether or not a selected transport protocol is supported by the MSD 305. The connection manager service 325 can include a table that identifies any transfer protocols that require an AV transport service 320 to be established on the MSD 305.

The CP device 330 having a CP 335, uses a UPnP discovery service such as simple service discovery protocol (SSDP), or a similarly based protocol, to discover the MSD 305 and the MRD 350. Once the CP 335 discovers the MSD 305 and the MRD 350 on the UPnP network 300, the CP 335 works in conjunction with the MSD 305 to discover AV content stored in the media database 310, and with the MRD 350 to present some type of user interface that allow a user to browse for AV content and control AV content rendered on the MRD 350. Specifically, the CP 335, uses the CDS 315 of the MSD 305 to locate certain desired AV content. The CDS 315 allows searching and browsing of the AV content stored in the media database 310 by, for example, the artist of a song or the name of a video. Each item of AV content has information regarding that content, such as the transfer protocol the MSD 305 can use to transport the AV content to the MRD 350.

The MRD 350 is any device capable of actually rendering or playing back AV content, such as MPEG-4 formatted video, MP3 formatted audio, and JPEG formatted photos. Like the MSD 305, the MRD 350 also utilizes an AV transport service 355 and a connection manager service 360. Once the desired content has been discovered by the CP 335, the CP 335 compares the transfer protocol and format obtained from the CDS 315 of the MSD 305 and the connection manager service 360 of the MRD 350. Depending on what transfer protocol is chosen, the respective connection manager services 325 and 360 of the MSD 305 and the MRD 350 will establish an AV transport service, 320 and 355, respectively to control the transfer of the AV content from the MSD 305 to the MRD 350.

It should be noted that depending on the type of transfer protocol selected, an AV transport service may or may not be needed. Examples of possible transfer protocols that can be used are HTTP GET, real time streaming protocol (RTSP)/real time transport protocol (RTP), Institute of Electrical and Electronics Engineers (IEEE)-1394. Therefore, the actual transfer of AV content can occur between the MSD 305 and the MRD 350 and does not necessarily involve the UPnP network 300. In addition, the MRD 350 also utilizes a rendering control 365 to allow for the actual rendering of the AV content for presentation on an output, such as a speaker or TV, although the flow of the AV content from the MSD 305 and the MRD 350 can be controlled by the CP 335. This includes playing, fast-forwarding, rewinding, seeking, etc. of the AV content.

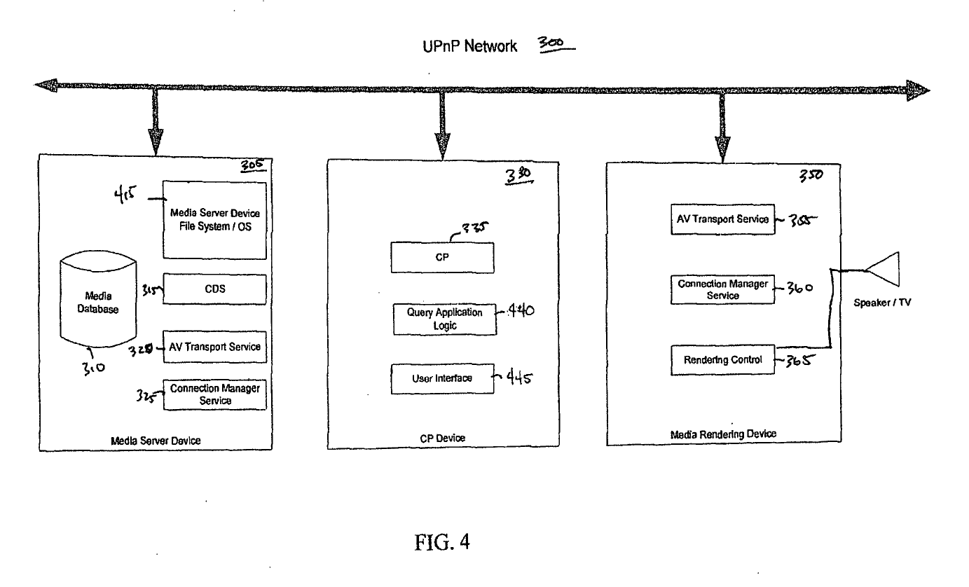

FIG. 4 depicts the same UPnP network 300 shown in FIG. 3, with the same MRD 350, and a MSD 305 and a CP 330 which include additional objects with which one embodiment of the present invention is implemented. A query application logic object 440 is implemented in the CP device 330 which would allow the CP 335 to send a query, using simple object access protocol (SOAP) to the CDS 315 of the MSD 305 requesting the remaining free storage capacity available on the media database 310. A “hook” is simply implemented between the CDS 315 and the MSD file system/operating system (OS) 415 of the MSD 305, allowing the CDS to access this information from the media database 310. Additionally, the query action is added to the user interface 445 that already displays controls representing actions such as the fast-forwarding, rewinding, and seeking described above. It should be noted that adding such a query action to the CDS 315 requires that the CDS service description extensible markup language (XML) files of the MDS 305 be updated to include the new query action. This may or may not require defining a new state variable for this purpose. In addition, the query action is implemented in the CDS 315 software as well, where invoking the query action causes the remaining free storage capacity to be returned as an argument, which the CP 335 in turn receives. It should be further noted that the new query action is defined to be an optional action. Therefore, UPnP AV media servers utilizing this feature are backward compatible with older CPs that do not necessarily support the new query action. In other words, the older CPs simply do not have to utilize the new query action.

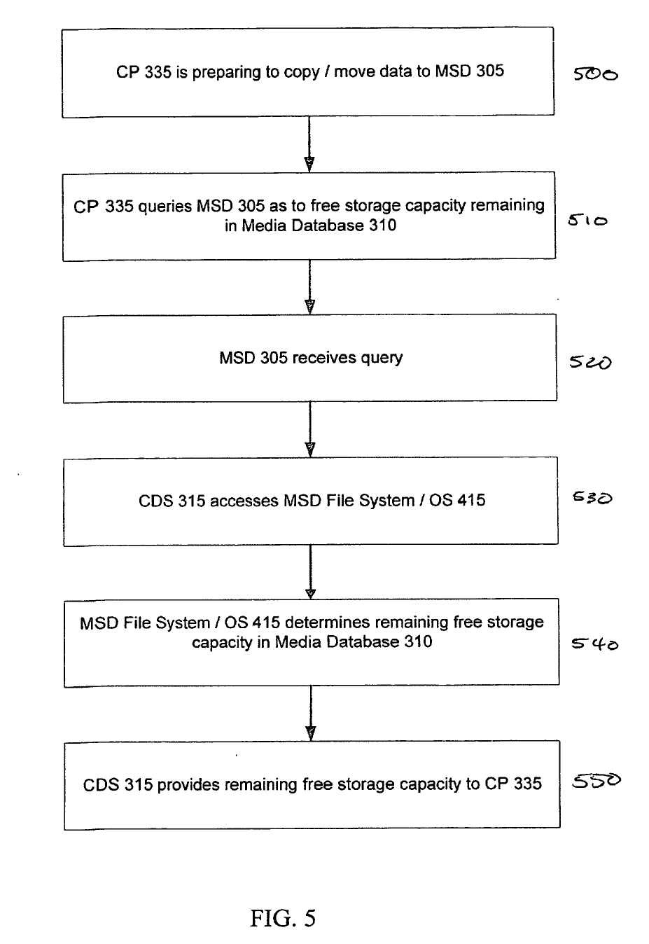

FIG. 5 is a flow diagram showing a process by which the one embodiment of the present invention is implemented. At 500, the CP 335 is preparing to copy or move AV content-based data to the MSD 305. The CP 335 sends a query request to the MSD 305 as to the free storage capacity remaining in media database 310 at 510. At 520, the MSD receives the query via the CP 335 communicating with the CDS 315 as it would in processing any other action as already described above, such as for searching or browsing for AV content in the media database 310. At 530, the CDS 315 accesses the MSD file system/OS 415, the MSD file system/OS 415 having the ability to determine any remaining free storage capacity on the media database 310. At 540, the remaining free storage capacity in the media database 310 is determined, and at 550, the CDS 315 forwards the capacity information to the CP 335 for presentation.

In a second embodiment, the query action is implemented as a dedicated AV media server service instead of another selectable action or option available to a user of the UPnP network 300 or the MSD 305. The procedures allowing the remaining free storage capacity to be queried are similar to those already described, except that the query action itself would be implemented outside of the CDS 315. Therefore, a new service, e.g., “Free_Capacity_Service” is defined to perform at least one action to query the remaining free storage capacity of the media database 310.

In a third embodiment, UPnP eventing and a state variable to indicate the remaining free storage capacity is used to inform a user of the capacity information of the media database 310. A new state variable, e.g., “Remaining_Free_Storage_Capacity” is defined in the service description file of the CDS 315. The CP 335 subscribes to an event that indicates, for example, when a predefined lower limit is reached or passed. It should be noted that the predefined lower limit can be defined in the event subscription. The CDS 315 monitors the remaining free storage capacity of the media database 310, and compares it to the predefined lower limit, which is given as an argument. When the remaining free storage capacity of the media database 310 reaches or passes the predefined lower limit, the CDS 315 will send an event to the CP 335 indicating this condition. It should further be noted that the eventing mechanism utilized has been defined in the UPnP DA v1.0.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method for querying a media database of a media server device to determine a remaining free storage capacity of the media database comprising:
initiating a query to a content directory service of the media server device, wherein the query is forwarded from the content directory service to a file system of the media server device; and
receiving the remaining storage capacity of the media database, wherein the file system of the media server device accesses the media database to determine the remaining free storage capacity of the media database.

2. The method of claim 1, wherein a control point initiates the query to the content directory service using a simple object access protocol.

3. The method of claim 2, further comprising a universal plug and play network communicatively connecting the control point with the media server device.

4. The method of claim 3, wherein the universal plug and play network transports audio-visual content therein.

5. The method of claim 4, wherein the query comprises a universal plug and play status action to the content directory service

6. The method of claim 5, wherein the universal plug and play status action is defined in a service that is implemented outside of the content directory service.

7. The method of claim 4, wherein the query is performed prior to transferring audio-visual content to the media server device.

8. The method of claim 4, wherein the query is performed subsequent to transferring audio-visual content to the media server device.

9. The method of claim 1, wherein the file system of the media server device comprises an operating system of the media server device.

10. A computer program product for querying a media database of a media server device to determine a remaining free storage capacity of the media database comprising:
computer code for initiating a query to a content directory service of the media server device, wherein the query is forwarded from the content directory service to a file system of the media server device; and
computer code for receiving the remaining storage capacity of the media database, wherein the file system of the media server device accesses the media database to determine the remaining free storage capacity of the media database.

11. The computer program product of claim 10, wherein a control point initiates the query to the content directory service using a simple object access protocol.

12. The computer program product of claim 11, further comprising a universal plug and play network communicatively connecting the control point with the media server device.

13. The computer program product of claim 12, wherein the query comprises a universal plug and play status action to the content directory service.

14. The computer program product of claim 13, wherein the universal plug and play status action is defined in a service that is implemented outside of the content directory service.

15. An electronic device for querying a media database of a media server device to determine a remaining free storage capacity of the media database comprising:
a query application logic;
a control point communicatively connected to the query application logic including:
computer code for initiating a query to a content directory service of the media server device, wherein the query is forwarded from the content directory service to a file system of the media server device; and
computer code for receiving the remaining storage capacity of the media database, wherein the file system of the media server device accesses the media database to determine the remaining free storage capacity of the media database; and
a user interface communicatively coupled with the query application logic configured to present the remaining free storage capacity to a user of the media server device.

16. The electronic device of claim 15, wherein the control point communicatively connects with the media server device via a universal plug and play network.

17. The electronic device of claim 16, wherein the query comprises a universal plug and play status action to the content directory service.

18. The electronic device of claim 17, wherein the universal plug and play status action is defined in a service that is implemented outside of the content directory service.

19. A system for querying a media database of a media server device to determine a remaining free storage capacity of the media database comprising:
a universal plug and play network communicatively coupling at least one media server device and at least one control point;
a query application logic configured to instruct the control point to initiate a query;
a content directory service of the media server device configured to receive the query from the control point and forward the query to a file system of the media server device, wherein the file system of the media server device determines the remaining storage capacity of the media database; and
a user interface configured to present the remaining free storage capacity to a user of the media server device.

20. A method for determining a remaining free storage capacity of a media database in a media server device comprising:
subscribing to an event, wherein the event indicates that the remaining free storage capacity of the media database has at least reached a predetermined limit; and
receiving the event when a content directory service of the media server device, having defined therein a state variable representative of the remaining free storage capacity of the media database, determines that the remaining free storage capacity of the media database has at least reached the predetermined limit after monitoring the remaining free storage capacity of the media database and comparing it to the predetermined limit.

21. A system for determining a remaining free storage capacity of a media database in a media server device comprising:
a universal plug and play network communicatively coupling at least one media server device and at least one control point; and
a content directory service of the media server device configured to monitor the remaining free storage capacity of the media database and compare it to a predetermined limit, the content directory service, further including:
a state variable representative of the remaining free storage capacity of the media database; and
an event mechanism configured to send an event to the at least one control point indicating that the remaining free storage capacity of the media database has at least reached the predetermined limit, wherein the at least one control point subscribes to the event.
